(19) United States
(12) Patent Application Publication
(10) Pub. No.: US 2025/0158450 A1
(43) Pub. Date: May 15, 2025

(54) Electrical Connector

(71) Applicant: Rosenberger Hochfrequenztechnik GmbH & Co. KG, Fridolfing (DE)

(72) Inventors: Max Reuther, Fridolfing (DE); Herbert Kozel, Fridolfing (DE)

(21) Appl. No.: 18/939,830

(22) Filed: Nov. 7, 2024

(30) Foreign Application Priority Data
Nov. 10, 2023 (EP) 23 208 959.9

(51) Int. Cl. H02J 50/00; H01Q 17/00; H02J 50/10; H02J 50/70; H02J 50/80

(52) U.S. Cl. CPC H02J 50/005; H01Q 17/008; H02J 50/10; H02J 50/70; H02J 50/80

(57) ABSTRACT

An electrical connector (1) comprises an antenna (3) for contactless data transfer and a sleeve-shaped coil (2) for contactless energy transfer. The sleeve-shaped coil (2) comprises a first leadthrough (4) between an air-interface-side axial end (5) of the sleeve-shaped coil (2) and an antenna-side axial end (6) of the sleeve-shaped coil (2). A sleeve-shaped electromagnetic absorber (7) comprises a second leadthrough (8) designed to allow propagation for an electromagnetic wave. The sleeve-shaped absorber (7) is arranged within the first leadthrough (4) and the antenna (3) is arranged relative to the antenna-side axial end (6) in such a way that a main radiating direction HR_{D} of the antenna (3) passes through the second leadthrough (8).

### CROSS-REFERENCE TO RELATED APPLICATIONS

This US Non-Provisional Utility Patent Application claims priority to earlier filed European Patent Application No. 23 208 959.9, which was filed on 10 Nov. 2023. The entire contents of the aforementioned earlier filed European Patent Application is expressly and fully incorporated herein by this reference.

Pursuant to USPTO rules, this priority claim to earlier filed European Patent Application No. 23 208 959.9, which was filed on 10 Nov. 2023, is also included in the Application Data Sheet (ADS) filed herewith.

### FIELD OF THE INVENTION

The present invention relates to an electrical connector.

### BACKGROUND OF THE INVENTION

In a pluggable and re-releasable connection for transferring data and electrical energy, electrical plug-in connections comprising an electrical plug-in connector and an associated electrical mating plug-in connector are known. In the plugged state of the plug-in connection, contact elements of the electrical plug-in connector make contact with associated electrical mating contact elements of the mating plug-in connector.

During high plug-in cycles of a plug-in connection, abrasion occurs at the contact elements. Over the course of time, oxidations form on the contact elements. During the transfer of electrical energy, a sparkover between the contact elements occurs in each case in the plugging process and in the releasing process of a plug-in connection for energy transfer. In all three cases, the electrical transfer characteristic of the plug-in connection permanently deteriorates. In order to overcome the technical disadvantages mentioned, DE 10 2021 108 236 A1 describes a coupling system for wireless, and thus contactless, data and energy transition between two coupling devices. The coupling device comprises a communication device for wireless data transfer and a coil comprising a ferrite core for wireless energy transfer.

However, presently available electrical connectors for contactless energy and data transfer are greatly limited in terms of their data rate and cannot keep up with contacting connectors in respect of this point. In this regard, commercially available connectors provide a maximum data rate of 100 Mbit/s. Consequently, the transfer of fast Ethernet protocols, such as Gigabit Ethernet for example, is therefore not possible. Moreover, available contactless connectors have the disadvantage of a high power consumption on account of complex electronic circuits for signal processing of the data transfer. This increased power consumption ultimately leads to a reduction of the efficiency of the energy transfer.

Against this background, the present invention is based on the object of improving the transfer quality between the two coupling devices.

Accordingly, provision is made for an electrical connector comprising an antenna for contactless data transfer, a sleeve-shaped coil for contactless energy transfer comprising a first leadthrough between an air-interface-side axial end of the coil and an antenna-side axial end of the coil and a sleeve-shaped electromagnetic absorber comprising a second leadthrough designed to allow propagation for an electromagnetic wave or designed in particular such that an electromagnetic wave is able to propagate through the second leadthrough or in the second leadthrough, wherein the absorber is arranged within the first leadthrough and the antenna is arranged relative to the antenna-side axial end in such a way that a main radiating direction HR_{D} of the antenna passes through the second leadthrough.

Herein the leadthrough of the coil is referred to as first leadthrough and the leadthrough of the absorber is referred to as second leadthrough. Since the absorber is arranged in the first leadthrough and the main radiating direction of the antenna passes through the second leadthrough, portions of the emitted electromagnetic wave and/or of the received electromagnetic wave which, in each case, do not propagate along the main radiating direction of the antenna are absorbed by the absorber and thus advantageously not reflected at the coil. Consequently, a multipath propagation of the electromagnetic wave can be prevented or at least reduced. This leads to lower channel distortions and thus to a decrease in the bit error rate and/or to an increase in the data rate during a communication between a connector and a mating connector.

On account of the lower channel distortions, a lower signal processing complexity and thus a lower energy demand are required. This improves the efficiency of the energy transfer.

An electromagnetic absorber, in particular a radiofrequency absorber, is produced from a material which at least damps or preferably prevents a reflection of an incident electromagnetic wave. In this case, the absorber of an electrical connector both absorbs portions of the electromagnetic wave emitted by the antenna of the electrical connector and absorbs portions of the electromagnetic wave emitted by the antenna of the electrical mating connector. During its propagation in the interior of the coil, the electromagnetic wave consequently can no longer reach the coil, or can reach it at least only in an attenuated manner, and thus is not reflected at the coil, or is reflected only in an attenuated manner. In this case, the absorber has with preference a transmission damping of at least 40 dB/cm, preferably of at least 60 dB/cm, particularly preferably of at least 70 dB/cm, at the carrier frequency of the electromagnetic wave to be transferred in the data transfer.

The absorber is of sleeve-shaped design. Here and hereinafter Herein a sleeve-shaped absorber should be understood to mean an absorber body comprising the second leadthrough along a longitudinal axis. The second leadthrough is designed in such a way that an electromagnetic wave can propagate therein. Consequently, the second leadthrough can preferably be filled with air. Alternatively, the second leadthrough can be at least partly filled with a dielectric material which only slightly damps an electromagnetic wave. In this case, a slight damping of the dielectric material should be understood to mean in particular a transmission damping of less than 10 dB/cm, preferably less than 5 dB/cm, particularly preferably less than 3 dB/cm, at the carrier frequency of the electromagnetic wave to be transferred in the data transfer. Alternatively, the damping of the dielectric material may be specified by way of the tangent of the dielectric loss angle 8. In this case, a slight damping should be understood to mean in particular a tan (8) of less than 0.05, preferably of less than 0.025, particularly preferably of less than 0.01, at the carrier frequency of the electromagnetic wave to be transferred in the data transfer.

The second leadthrough is preferably enveloped by a sheath region of the absorber. At least one of the two lateral ends of the sleeve-shaped absorber is preferably designed to be open in each case or at least partly filled in each case with a dielectric material having a slight damping.

Preferably, the sheath region of the sleeve-shaped absorber has a sufficient minimum wall thickness. The minimum wall thickness is preferably at least 1 mm, particularly preferably more than 5 mm. The wall thickness of the sleeve-shaped absorber can be made constant, but can also be realized as variable in a longitudinal extent direction and/or in a circumferential direction.

The sheath region can be designed to be free of perforations in order to cause an electromagnetic wave incident on the sheath region to be absorbed to the fullest possible extent. According to the invention, the sheath region of the absorber can also comprise leadthroughs, for example slots, and/or pores. As a result, the effective relative permittivity ϵᵣ of the absorber can be reduced. This can lead to a higher reflection damping of the absorber.

The geometry of the absorber, in particular the outer geometry of the absorber, is preferably dimensioned such that a gap, preferably an air gap, is situated between an outer sheath of the absorber and the coil. Consequently, the absorber can be aligned directly at the antenna, without the coil influencing the relative position of the absorber with respect to the antenna. The outer geometry of the absorber preferably corresponds to the inner geometry of the first leadthrough.

Herein an electrical connector for contactless transfer of electrical energy and data is understood to mean in particular a device which is designed to transfer electrical energy and data to an associated electrical mating connector by way of emission and reception of electromagnetic fields. The connector and the mating connector can be arranged without contact, with mutual contact or in a mutual mechanical connection, for example in a plug-in connection. The connector and the mating connector can move translationally and/or rotationally relative to one another during operation. It is thus possible to avoid for example the use—particularly liable to wear—of sliding contacts and/or of concomitantly moving cables that are thus subjected to mechanical loading. Alternatively, the connector and the mating connector can also be fixed rigidly with respect to one another.

The connector comprises an antenna for contactless data transfer. In this case, various antenna types are possible in the context of the invention. In particular, the antenna can be designed as a flat antenna, for example as a patch antenna or as a slot antenna. Alternatively or supplementarily, a horn antenna and/or other antenna types can also be used. The antenna can also comprise one or more antenna arrays, for example a transmitting antenna array and a receiving antenna array or a common transmitting-receiving antenna array.

The main radiating direction of an antenna is a direction In the directional diagram of the antenna in which the antenna can emit a maximum power and receive a maximum power. The main radiating direction is therefore both the main emitting direction and the main receiving direction.

Furthermore, the electrical connector comprises a sleeve-shaped coll. Herein a sleeve-shaped coil is understood to mean a coil body comprising a spirally or helically curved and electrically conductive wire. The coil of the connector, if an alternating current flows through it, can induce an alternating current in a laterally arranged and likewise sleeve-shaped coil of a mating connector. In this way, energy can be inductively transferred between the connector and the associated mating connector in each case in one direction. A power of between 1 mW and 10 KW, preferably between 1 W and 100 W, can be transferred in the contactless energy transfer.

Various geometric shapes of the coil are possible. The cross-sectional profile orthogonal to the longitudinal axis of the coil can be circular, elliptic or polygonal, i.e. n-gonal, in particular triangular, quadrilateral, pentagonal, hexagonal, heptagonal, octagonal, etc.

The first leadthrough of the coil extends between an air-interface-side axial end of the coil and an antenna-side axial end of the coil. The antenna-side axial end is the axial end of the coil facing the antenna. The air-interface-side axial end is the axial end of the coil facing away from the antenna.

According to the invention, the sleeve-shaped absorber is arranged within the first leadthrough of the sleeve-shaped coil and the antenna is arranged relative to the antenna-side axial end of the coil in such a way that a main radiating direction of the antenna passes through the second leadthrough. This ensures that a large portion of the electromagnetic wave which is emitted by the antenna and/or is received by the antenna can propagate both within the sleeve-shaped coil and within the second leadthrough of the sleeve-shaped absorber. Portions of the emitted and/or received electromagnetic wave which do not propagate parallel to the main radiating direction of the antenna of the connector can impinge on the inner sheath surface of the absorber and advantageously be absorbed by the absorber.

Advantageous configurations and developments are evident from the the description with reference to the figures of the drawing.

The features mentioned herein can be used not only in the respectively specified combination but also in other combinations or by themselves, without departing from the scope of the present invention.

In one preferred embodiment of the invention, the absorber can extend at least over a longitudinal extent of the first leadthrough of the coil. This has the advantage that an inner sheath surface of the coil is completely masked or covered by the absorber. Consequently, the beam path from the antenna of the connector and of the mating connector to the coil is preferably completely interrupted, such that reflections of the electromagnetic wave at the coil cannot occur to the greatest possible extent.

In one likewise possible embodiment of the connector, it is also possible for only a part of the inner sheath surface of the coil to be masked or covered by the absorber. In particular, it is advantageous if more than 50%, preferably more than 90%, particularly preferably more than 95%, of the inner sheath surface of the coil is masked or covered by the absorber. Consequently, at least some of the reflections of an electromagnetic wave at the coil can be prevented.

In a further preferred embodiment of the invention, the absorber can extend in a longitudinal direction as far as the antenna. The antenna can preferably be arranged outside the first leadthrough of the coil. This has the advantage that the magnetic field generated by the coil does not pass, or only slightly passes, through the antenna and/or optionally associated electronics. Consequently, the induction of eddy currents in the antenna and the associated electronics is prevented or at least reduced.

In the case of an antenna arranged in a manner spaced apart axially from the coil, a longitudinal extent of the absorber as far as the antenna can prevent an electromagnetic wave from impinging on a body arranged in the interspace between the coil and the antenna. Consequently, said electromagnetic wave is not reflected, or at least is reflected to a lesser extent. Said body can preferably be a ferrite core which is arranged adjacent to the coil and which guides the magnetic field generated by the coil at least in a section of the associated magnetic field lines.

The sleeve-shaped absorber can be embodied as a loss-based absorber and/or as a resonance-based absorber.

The loss-based absorber can comprise loss-causing particles, such as graphene, carbon fibers and/or metamaterials, for example, which are embedded in a base material, such as an elastomer, a foam, a thermoplastic or a thermosetting plastic. The loss-causing particles damp the electromagnetic wave penetrating into the absorber.

The resonance-based absorber suppresses reflections at its outer surface by virtue of the fact that the electromagnetic wave incident on it partly is reflected at its outer surface and partly penetrates into the absorber. A further, second reflection of that portion of the electromagnetic wave which penetrates into the absorber at the interface between the absorber and the material on which the absorber is mounted is retarded by 180° in its phase in relation to the first reflection owing to the thickness of the absorber and can thus be destructively superimposed with the first reflection at the outer surface of the absorber.

In one advantageous development of the invention, the sleeve-shaped absorber can be embodied with loss-based absorber material.

In one advantageous development of the invention, provision can be made for the absorber to comprise a flange-shaped region in each case at the air-interface-side axial end and/or at the antenna-side axial end of the coil. A flange-shaped region of the absorber can thus mask or cover an axial end of the coil. In the case of a section of the ferrite core that is arranged in particular at the antenna-side axial end of the coil, the flange-shaped region of the absorber can also axially mask or cover this section of the ferrite core in order to reduce reflections. In the case of a flange-shaped region of the absorber at the air-interface-side axial end of the coil, reflections between the connector and the mating connector can be minimized.

The absorber can be of integral or multipartite design. In one particularly preferred development of the connector, the flange-shaped region of the absorber can be of discrete-part design with respect to the sleeve-shaped region of the absorber. As a result, an absorber without a flange-shaped region can be supplemented to form an absorber with flange-shaped regions cost-effectively by way of common part utilization. If the absorber is of multipartite design, a force-locking, interlocking or integrally bonded connection between the segments of the absorber is possible in each case. The segments of the absorber can be separated by a gap. The thickness of the gap is preferably a maximum of 0.5 mm.

In the flange-shaped region of the absorber, the absorber material can preferably be produced from a material comprising an elastomer, for example a silicone, or a foam. The elastomer and the foam can each be a composite material as explained above. This is advantageous in particular if the external diameter is significantly greater than the axial thickness of the flange-shaped region, for example, but not limited to, by a factor of 3, by a factor of 5 or by a factor of 10. In an injection-molding method, flat bodies are not producible, or are producible only with difficulty.

It can be particularly advantageous if a diameter of the second leadthrough increases laterally or radially in the direction of an air-interface-side axial end of the absorber. The air-interface-side axial end of the absorber is further away than the antenna-side axial end of the absorber relative to the antenna. The increase in the internal diameter of the absorber can particularly advantageously be of stepped or conical design. Technical investigations by the inventors have shown that an electromagnetic wave reflected at the mating connector is advantageously damped as a result.

The sleeve-shaped absorber in which the diameter of the second leadthrough increases laterally or radially in the direction of the air-interface-side axial end of the absorber can be of discrete-part construction. For example, the absorber, on the antenna side, can comprise a first absorber unit mounted directly on the antenna. If the antenna is one mounted on a printed circuit board, for example the first absorber unit can be positionally accurately placed on the printed circuit board and thus accurately aligned relative to the antenna by means of a printed circuit board placement process. In this case, the first absorber unit comprises a part of the second leadthrough of the absorber by virtue of the fact that it itself has a first through opening, within which the antenna lies. As a result of the accurate alignment, a longitudinal axis of the first through opening can pass through the antenna midpoint and/or through the phase center of the antenna.

The absorber can furthermore comprise a second absorber unit, which can be of sleeve-shaped design and comprises a second through opening as a further part of the second leadthrough. The internal diameter of the second through opening can correspond to the external diameter of the first absorber unit. A longitudinal extent of the second absorber unit can be longer than a longitudinal extent of the first absorber unit. In a mounting process, the second absorber unit can thus be plugged onto the first absorber unit by means of a press fit. Consequently, the second absorber unit can be aligned accurately with respect to the first absorber unit, such that a longitudinal axis of the second through opening can be aligned with a longitudinal axis of the first through opening. The overall result is therefore an accurate alignment of the longitudinal axis of the second leadthrough of the absorber relative to the antenna.

Optionally, the absorber can comprise a third absorber unit, which on the air interface side can form the flange-shaped region of the absorber and be of discrete-part design with respect to the first and second absorber units. The third absorber unit can be mounted on the air-interface-side end surface of the coil. The second absorber unit can extend from the antenna or from a printed circuit board carrying the antenna as far as the third absorber unit in the longitudinal direction and can thus be held by the third absorber unit in an interlocking, force-locking or integrally bonded manner. An absorber that masks all components of the connector between the antenna and the air-interface-side axial end of the coil can thus be provided.

As already mentioned, the electrical connector can additionally comprise a ferrite core, which can preferably run along an outer sheath surface of the coil and/or an end surface of the coil formed at the antenna-side axial end. In this case, the ferrite core is preferably arranged adjacent to the coil. The ferrite core can preferably comprise a third leadthrough, which can be aligned with the first leadthrough of the coil. In this case, the absorber can advantageously additionally extend at least along the longitudinal extent of the third leadthrough in order to prevent reflections of an electromagnetic wave at the ferrite core.

In a further preferred embodiment of the invention, the coil can be configured to inductively transfer energy in a first frequency range, while the antenna can be configured to transfer data in a second frequency range different than the first frequency range. The absorber can be configured to be electromagnetically transmissive in particular to an alternating magnetic field in the first frequency range and to be electromagnetically absorbent in particular for an electromagnetic wave in the second frequency range. As a result, reflections of the electromagnetic wave transporting the data signal can be reduced, without the inductive transfer of energy between connector and mating connector being damped.

In this case, being electromagnetically transmissive means that the transmission damping of the absorber is preferably less than 10 dB/cm, particularly preferably less than 5 dB/cm. In this case, being electromagnetically absorbent means that the transmission damping of the absorber is parameterized as mentioned herein.

Advantageously, the upper end of the first frequency range lies below the lower end of the second frequency range. By way of example, the first frequency range can lie between 0.5 kHz and 10 MHz or optionally occupy a sub-range therein. Alternatively, the upper end of the first frequency range can also be a maximum of 100 MHz, for example. The first frequency range can also just involve an oscillation of a specific frequency between 0.5 kHz and 100 MHz. By way of example, the second frequency range can lie between 1 GHz and 500 GHz or occupy a sub-range thereof. Particularly preferably, the second frequency range can lie between 57 GHz and 64 GHz. The lower end of the second frequency range can alternatively be 0.5 GHz or 10 GHz, for example. In particular, it can be advantageous if the upper end of the first frequency range lies below the lower end of the second frequency range by at least a factor of 10, a factor of 100 or a factor of 1000. It is thus possible to find materials and/or geometries which have the property of being electromagnetically absorbent in the second frequency range and electromagnetically transmissive in the first frequency range.

In one advantageous development of the electrical connector, the antenna can be of circularly polarized design and/or the main radiating direction of the antenna can be aligned with a longitudinal axis of the second leadthrough.

If the connector rotates relative to the mating connector about a longitudinal axis of the second leadthrough of the connector, then the circularly polarized antennas of connector and mating connector enable a data transfer independent of the rotation angle.

The preferred alignment of the main radiating direction with the longitudinal axis of the second leadthrough has, at least, the following advantages: The absorber surrounds the electromagnetic wave emitted by the antenna, without an axial offset with respect to the antenna midpoint. This can maintain the circular polarization of the electromagnetic wave in the propagation through the second leadthrough and/or foster the transmitting-receiving isolation of the antenna.

In a further preferred embodiment of the invention, the second leadthrough can be of rotationally symmetrical design. The transmitting-receiving isolation of the antenna can be improved as a result. This can be advantageous in particular in the case of an antenna configured for an in-band full-duplex data transfer. The rotational symmetry of the second leadthrough can moreover improve the transfer quality in the event of a rotation of the connector relative to the mating connector about the longitudinal axis of the second leadthrough of the connector.

In a further preferred embodiment of the invention, the antenna of the connector and of the mating connector can be configured to carry out an in-band full-duplex data transfer. This means that the antenna transfers simultaneously in the same frequency band both in the receiving direction and in the transmitting direction. Thus, during an in-band full-duplex data transfer, the required bandwidth can be halved compared with a frequency duplex or alternatively the data rate can be doubled. In this case, preferably, a center axis of the antenna can be aligned with a longitudinal axis of the second leadthrough.

An antenna configured to carry out an in-band full-duplex data transfer can be characterized by its transmitting-receiving isolation. The transmitting-receiving isolation describes the isolation between a transmitting signal path of the connector that is electrically connected to the antenna and a receiving signal path of the connector that is electrically connected to the antenna. For an in-band full-duplex data transfer, the transmitting-receiving isolation can be greater than 30 dB, particularly preferably greater than 40 dB. The transmitting-receiving isolation constitutes the reciprocal of the transmission scattering parameter from the transmitting signal path to the receiving signal path.

There are various embodiments for an antenna configured to carry out an in-band full-duplex data transfer. For example, the antenna can comprise a common transmitting-receiving antenna, to which both the transmitting signal path and the receiving signal path are electrically connected for example via a circulator. Additionally or alternatively, orthogonal modes of the antenna can be assigned to a transmitted signal and a received signal of the electrical connector.

Alternatively, the antenna can comprise at least one transmitting antenna to which the transmitting signal path is connected, and at least one receiving antenna to which the receiving signal path, which is independent of the transmitting signal path, is connected. In this case, the transmitting and receiving antennas can be spatially spaced apart from one another far enough so that the required transmitting-receiving isolation can be achieved. Additionally or alternatively, the transmitting and receiving antennas can be cross-polarized with respect to one another. Additionally or alternatively, a decoupling structure, for example an electromagnetic absorber, a meta-surface or a shielding wall, can be arranged between the at least one transmitting antenna and the at least one receiving antenna. A further possibility for in-band full-duplex data transfer consists in the antenna comprising at least two transmitting antennas and at least one receiving antenna and the crosstalk from the transmitting antennas to all the receiving antennas being canceled in each case.

The antenna can comprise a transmitting antenna group having a first transmitting antenna, a second transmitting antenna and a first balun, and a receiving antenna group having a first receiving antenna, a second receiving antenna and a second balun, wherein the first transmitting antenna and the second transmitting antenna are each connected to a balanced port of the first balun and the first receiving antenna and the second receiving antenna are each connected to a balanced port of the second balun, wherein an unbalanced port of the first balun is connected to a transmitting signal path of a transceiver arrangement of the connector and an unbalanced port of the second balun is connected to a receiving signal path of the transceiver arrangement, said receiving signal being independent of the transmitting signal path, and wherein the first transmitting antenna, the second transmitting antenna, the first receiving antenna and the second receiving antenna have a relative spatial position with respect to one another, such that crosstalk between the transmitting antenna group and the receiving antenna group is at least reduced by the differential interconnection of the respective antennas thereof, wherein each of the receiving antennas has the same center-to-center distance with respect to both transmitting antennas.

In one preferred embodiment of the invention, the antenna comprises a pair of planar transmitting antennas and a pair of planar receiving antennas, which can be arranged in each case in a crossed manner preferably at right angles to one another on a printed circuit board. In this case, a center axis which runs through a midpoint of the two pairs and is oriented perpendicularly to the printed circuit board can be aligned with a longitudinal axis of the second leadthrough. In this case, the pair of transmitting and receiving antennas can be arranged in each case preferably in a crossed manner on a circular line. The transmitting antennas can be driven by a differential transmitted signal. As a result, the signals of the transmitting antennas can be destructively superimposed in each case at the receiving antennas, such that the transmitting-receiving isolation of the antenna can be improved.

In accordance with one advantageous development of the invention, at least one region of the absorber can be produced from a material which comprises a thermoplastic or thermosetting plastic material, and can be fixed to the antenna directly, in particular preferably by means of a press fit.

In one preferred embodiment of the absorber, the absorber is completely produced from a thermoplastic or thermosetting plastic material or composite material. It is thus possible to attain a sufficient mechanical strength for securing the absorber to the antenna or to the printed circuit board on which the antenna is formed.

In a further preferred embodiment, the absorber can comprise a layered structure composed of an inner sleeve and an outer sleeve. In this case, the inner sleeve can be produced from a material comprising an elastomeric or a foamlike absorber material, while the outer sleeve can comprise a thermoplastic or thermosetting plastic absorber material. As an alternative to the outer sleeve, the absorber can be secured to a preferably sleeve-shaped holding element preferably composed of a dielectric solid material. Generally, the holding element can comprise a stiff material such as, for example, a plastic, a natural substance or a composite material. The absorber composed of an elastomer material or composed of a foam material can be secured to the holding element for example by means of adhesive bonding, for example by way of a pressure-sensitive, double-sided adhesive film and/or by way of an epoxy adhesive. The absorber can be secured to the antenna preferably by means of a press fit or by means of adhesive bonding.

Securing the absorber or the holding element directly to the antenna makes it possible to minimize the manufacturing tolerance chain and thus advantageously to reduce or avoid a lateral or radial offset between the absorber and the antenna. This can foster an improved transmitting-receiving isolation of the antenna. Moreover, an improved coaxiality of the main radiating direction of the antenna and the longitudinal axis of the second leadthrough of the absorber can thus be attained.

One optional development of the invention comprises an integrated transmitter circuit and also an integrated receiver circuit. These can for example be arranged on a common printed circuit board with the antenna and be electrically connected thereto. In this case, the integrated transmitter circuit comprises at least a radiofrequency mixer and an oscillator for generating a carrier oscillation. The oscillator can optionally be a free-running oscillator. Carrier frequency control by way of a phase locked loop can thus be dispensed with, which can save power. The transmitter circuit can optionally additionally be designed to carry out an amplitude modulation. The receiver circuit can optionally comprise an incoherent demodulator, for example an envelope detector, in order to demodulate the data signal from the received carrier oscillation. In this regard, in the receiver circuit, the generation of an oscillator signal can be dispensed with and power can thus be saved. The efficiency of the energy transfer can thus be improved.

The invention also relates to a system comprising an electrical connector and an associated electrical mating connector. The technical features, technical embodiments and technical aspects explained in detail above in respect of the connector equivalently apply to the connector and the mating connector. In this case, an air interface of the connector is arranged opposite an air interface of the mating connector. At least the connector and/or the mating connector are/is designed in each case to be rotatable about a longitudinal axis of the respective second leadthrough. If the longitudinal axes of the second leadthrough of the connector and of the mating connector are aligned, then the two connectors can be rotated relative to one another preferably about the two aligned longitudinal axes. In this case, the rotational movement can be effected in a defined angular segment or through a solid angle of 0° to 360°.

An air gap having a thickness of with preference between 0 cm and 20 cm, in particular between 0 cm and 5 cm, particularly preferably between 0.05 cm and 1 cm, can be present between the air interfaces of the two connectors. In principle, the distance between the two connectors is variable, preferably within the distances mentioned.

In one development of the system, the axes of the two connectors can be tilted relative to one another. In this case, the air interfaces of the two connectors are opposite one another in a skew plane. This can preferably be done in an angular range of −10° to +10°. This can be achieved by expanding the radiation lobe of the antenna,

The above configurations and developments can be combined with one another in any desired manner, insofar as is feasible. Further possible configurations, developments and implementations of the invention also encompass not explicitly mentioned combinations of features of the invention described above or below with respect to the exemplary embodiments. In particular, in this case, a person skilled in the art will also add individual aspects as improvements or supplementations to the respective basic form of the present invention.

### SUMMARY OF THE INVENTION

The disclosed invention is an electrical connector that generally provides an antenna (3), a sleeve-shaped coil (2) and a sleeve-shaped electromagnetic absorber (Z).

A principal aspect of the present invention is an electrical connector (1) comprising an antenna (3) for contactless data transfer, a sleeve-shaped coil (2) for contactless energy transfer comprising a first leadthrough (4) between an air-interface-side axial end(S) of the coil (2) and an antenna-side axial end (6) of the coil (2) and a sleeve-shaped electromagnetic absorber (7) comprising a second leadthrough (8) designed to allow propagation for an electromagnetic wave, wherein the absorber (7) is arranged within the first leadthrough (4) and the antenna (3) is arranged relative to the antenna-side axial end (6) in such a way that a main radiating direction HR_{D} of the antenna (3) passes through the second leadthrough (8).

A further aspect of the present invention is an electrical connector (1) characterized in that the absorber (7) extends at least over a longitudinal extent of the first leadthrough (4).

A further aspect of the present invention is an electrical connector (1) characterized in that the absorber (7) extends in a longitudinal direction as far as the antenna (3),

A further aspect of the present invention is an electrical connector (1) characterized in that the absorber (7) is produced from a material comprising an elastomer or a foam, wherein the absorber (7) preferably on the outer sheath side is connected to a holding element (15-2) composed of a material preferably comprising a thermoplastic or thermosetting plastic absorber material.

A further aspect of the present invention is an electrical connector (1) characterized in that the absorber (7) comprises a flange-shaped region (19) in each case at the air-interface-side axial end (5) and/or at the antenna-side axial end (6) of the coil (2).

A further aspect of the present invention is an electrical connector (1) characterized in that the flange-shaped region (19) of the absorber (7) is of discrete-part design with respect to the sleeve-shaped absorber (Z).

A further aspect of the present invention is an electrical connector (1) characterized in that the flange-shaped region (19) of the absorber (7) is produced from a material comprising an elastomer or a foam.

A further aspect of the present invention is an electrical connector (1) characterized in that a diameter of the second leadthrough (8) increases laterally or radially in the direction of an air-interface-side axial end of the absorber (7).

A further aspect of the present invention is an electrical connector (1) characterized in that the electrical connector (1) additionally comprises a ferrite core (9), which preferably runs along an outer sheath surface of the coil (2) and an end surface of the coil (2) formed at the antenna-side axial end (6), wherein the ferrite core (9) comprises a third leadthrough (11), which is aligned with the first leadthrough (4) of the coil (2), wherein the absorber (7) extends at least along the longitudinal extent of the third leadthrough (11).

A further aspect of the present Invention is an electrical connector (1) characterized in that the coil (2) is configured to inductively transfer energy in a first frequency range, wherein the antenna (3) is configured to transfer data in a second frequency range different than the first frequency range, wherein the absorber (7) is configured to be electromagnetically transmissive in the first frequency range and electromagnetically absorbent in the second frequency range.

A further aspect of the present invention is an electrical connector (1) characterized in that the antenna (3) is circularly polarized and/or the main radiating direction HR_{D} of the antenna (3) is aligned with a longitudinal axis LA of the second leadthrough (8).

A further aspect of the present invention is an electrical connector (1) characterized in that the antenna (3) is configured to carry out an in-band full-duplex data transfer, wherein preferably a center axis of the antenna (3) Is aligned with a longitudinal axis La of the second leadthrough (8).

A further aspect of the present invention is an electrical connector (1) characterized in that the second leadthrough (8) is of rotationally symmetrical design.

A still further aspect of the present invention is an electrical connector (1) characterized in that at least one region of the absorber (Z) is produced from a material which comprises a thermoplastic or thermosetting plastic material and is fixed to the antenna (3) directly, in particular preferably by means of a press fit.

An even still further aspect of the present invention is a system (100) comprising an electrical connector (1) and an associated electrical mating connector (1 ′), wherein the connector (1) and the mating connector (1′) are in each case designed as an electrical connector (1 1′) and wherein an air interface (21) of the first connector (1) is arranged opposite an air interface (21′) of the mating connector (1 ′), and wherein at least the connector (1) and/or the mating connector (1′) are/is designed in each case to be rotatable about a longitudinal axis (L_{A}, L_{A}′) of the respective second leadthrough (8, 8′).

These and other aspects of the present invention are more fully set forth and disclosed herein.

### BRIEF DESCRIPTIONS OF THE FIGURES

The present invention is explained in greater detail herein on the basis of the exemplary embodiments specified in the schematic figures of the drawings.

FIG. 1 shows a longitudinal sectional illustration of a first embodiment of an electrical connector according to the invention comprising an electromagnetic absorber.

FIG. 2 shows a longitudinal sectional illustration of a second embodiment of an electrical connector according to the invention.

FIG. 3 shows an illustration of a linking of the absorber to the electrical connector according to the invention,

FIG. 4 shows a longitudinal sectional illustration of a third embodiment of an electrical connector according to the invention.

FIG. 5 shows a longitudinal sectional illustration of a fourth embodiment of an electrical according to the invention,

FIG. 6 shows a longitudinal sectional illustration of a fifth embodiment of an electrical connector according to the invention.

FIG. 7 shows a longitudinal sectional illustration of a sixth embodiment of an electrical connector according to the invention.

FIG. 8 shows a longitudinal sectional illustration of a seventh embodiment of an electrical connector according to the invention.

FIG. 9 shows a longitudinal sectional illustration of an eighth embodiment of an electrical connector according to the invention, and

FIG. 10 shows a longitudinal sectional illustration of a system comprising two electrical connectors according to the invention.

The accompanying figures of the drawing are intended to convey a further understanding of the embodiments of the invention. They illustrate embodiments and, in association with the description, serve to explain principles and concepts of the invention. Other embodiments and many of the advantages mentioned will become apparent from the drawings. The elements in the drawings are not necessarily shown in a manner true to scale in relation to one another.

In the figures of the drawings, identical, functionally identical and identically acting elements, features and components are each provided with the same reference signs, unless stated otherwise.

The figures are described in an interrelated and comprehensive manner herein.

### DETAILED WRITTEN DESCRIPTION OF THE PREFERRED EMBODIMENTS

This disclosure of the invention is submitted in furtherance of the Constitutional purposes of the US Patent Laws “to promote the progress of Science and the useful arts” (Article 1, Section 8).

In accordance with FIG. 1, the electrical connector 1 according to the invention for contactless data and energy transfer comprises a coil 2 for contactless energy transfer and an antenna 3 for contactless data transfer. The coil 2 is preferably designed as a cylindrical coil and has a longitudinal axis L_{S}. The antenna 3 is preferably designed as a flat antenna.

The coil 2 comprises a first leadthrough 4 between an air-interface-side axial end 5 and an antenna-side axial end 6. An electromagnetic absorber 7 is arranged in the first leadthrough 4 of the coil 2, said absorber preferably being of hollow-cylindrical design and comprising a second leadthrough 8. A longitudinal axis L_{A} of the absorber 7 is preferably aligned with the longitudinal axis L_{S} of the first leadthrough 4 of the coil 2.

To increase the inductance of the coil 2 and thus in order to increase the range of the contactless energy transfer, the magnetic flux generated by the coil 2 is partly guided in a ferrite core 9. The ferrite core 9 extends only in sections around the coil 2 and is preferably formed adjacent to the coil 2 only radially outside the coil 2 and only in a region at the antenna-side axial end 6 of the coil 2.

The antenna 3 is formed on a printed circuit board 10. The printed circuit board 10 can carry additional electronics units and radiofrequency components which are required for contactless data transfer, for example only. and without limitation, to transmitter and receiver circuits, radiofrequency couplers, etc. In order not to generate any unwanted eddy currents in the antenna 3 and in the electronics circuits on the printed circuit board 10, the printed circuit board 10 and the antenna 3 formed thereon are arranged in a manner spaced apart from the antenna-side axial end 6 of the coil 2 at least by the base wall thickness of the ferrite core 9.

The antenna 3 is additionally arranged symmetrically with respect to the longitudinal axis L_{A} of the second leadthrough 8. By way of example, the longitudinal axis L_{A} of the second leadthrough 8 can be oriented orthogonally to the antenna 3, provided that the latter is embodied as a flat antenna, and/or can run through the phase center of the antenna 3. If the antenna 3 optionally comprises one or more transmitting antennas and one or more receiving antennas separate from the transmitting antenna(s), the longitudinal axis L_{A} can run through a common midpoint of the transmitting and receiving antennas. The longitudinal axis L_{A} of the second leadthrough 8 can optionally correspond to a longitudinal axis of the absorber 7. The second leadthrough 8 can additionally be embodied as rotationally symmetrical with respect to its longitudinal axis L_{A}.

The antenna 3 thus emits an electromagnetic wave which propagates through the second leadthrough 8. Analogously, the antenna 3 receives an electromagnetic wave emitted by an antenna of the mating connector 1′ through the second leadthrough 8. Consequently, the main radiating direction HR_{D} of a bidirectional contactless data transfer between the connector 1 and the associated mating connector 1′ preferably lies on the longitudinal axis L_{A} of the second leadthrough 8. The main transfer direction HR_{E} of the preferably unidirectional contactless energy transfer from the connector 1 to the associated mating connector 1′ preferably lies on the longitudinal axis L_{S} of the first leadthrough 4.

The absorber 7 extends at least over the longitudinal extent of the first leadthrough 4 of the coil 2 in order to at least partly, preferably substantially, in particular completely, mask at least the inner sheath surface of the coil 2. Portions of an electromagnetic wave emitted or received by the antenna 3 which lie outside the main radiating direction HR_{D} on account of the directional characteristic of the antenna 3 impinge on the absorber 7, are absorbed by the latter, and consequently do not reach the coil 2, or reach it at least in a damped manner, such that reflections at the coil 2 are prevented or at least reduced.

In the first embodiment of a connector 1 according to the invention in accordance with FIG. 1, the absorber 7 extends from the first leadthrough 4 of the coil 2 beyond that through a third leadthrough 11 of the ferrite core 9 as far as the antenna 3 or as far as the printed circuit board 10 carrying the antenna 3. Such an elongation of the absorber 7 absorbs portions of an electromagnetic wave which propagate outside the main radiating direction HR_{D} to an axial section between the antenna-side axial end 6 of the coil 2 and the antenna 3 or the printed circuit board 10. Consequently, these portions are not reflected by a body arranged in said axial section, in particular the ferrite core 9. Finally, the absorber 7 as illustrated in FIG. 1 can also be lengthened beyond the air-interface-side axial end 5 of the coil 2 in order thereby additionally to confine the directional characteristic of the electromagnetic wave. Optionally, the absorber 7 and thus its second leadthrough 8 can extend from the antenna 3 as far as a cover 14 of the connector 1.

In the exemplary embodiment illustrated in FIG. 1, the absorber 7 can be fixed to the printed circuit board 10 in an integrally bonded manner, preferably by means of adhesive bonding. The absorber 7 is spaced apart from the coil 2 preferably by a small air gap.

For further mechanical stabilization and/or for connection of signals, the printed circuit board 10 is fixed on a securing carrier 12, which can comprise a further printed circuit board and additional electronics components. The connector 1 is incorporated in a housing 13, which can be connectable to the housing 13′ of the associated mating connector 1′. The housing 13 is closed off by a cover 14 on the air interface side, which cover is produced from an electrically nonconductive material, preferably from a plastic, in order to be transmissive to an electromagnetic wave. For this purpose, optionally, a thickness of the cover can be half a wavelength of the electromagnetic wave emitted and/or received by the antenna 3 in the material of the cover.

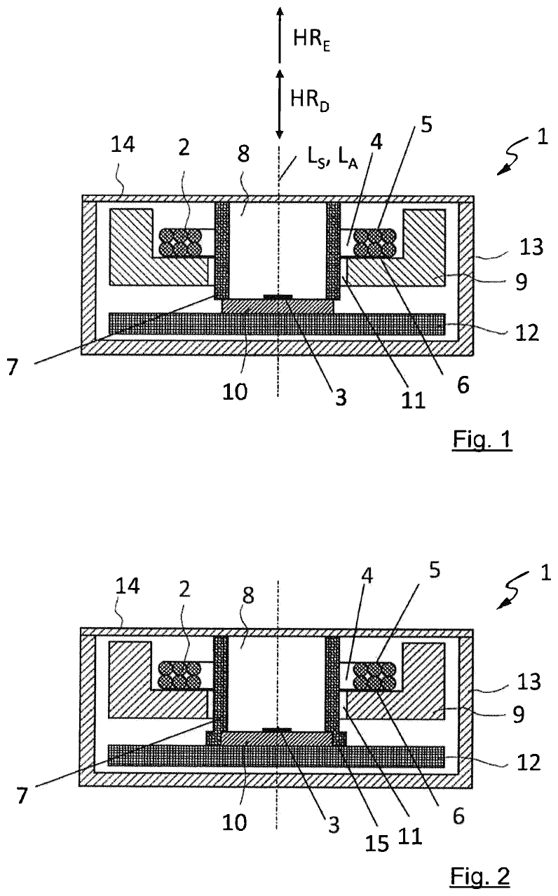

In the second exemplary embodiment of an electrical connector 1 according to the invention in accordance with FIG. 2, the absorber 7 is directly connected to the printed circuit board 10, in particular in a force-locking manner.

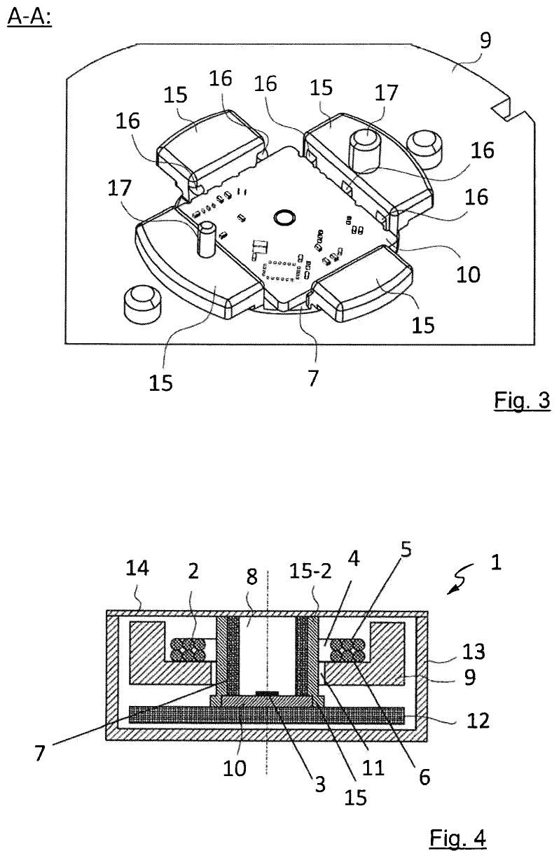

In accordance with FIG. 3, for this purpose, preferably four axial extensions 15 are formed on the absorber 7, which extensions encompass the preferably parallelepipedal printed circuit board 10 at respective side edges. In each case at least one projection 16 is formed on the axial extensions 15 of the absorber 7, said projection engaging around the printed circuit board 10 at the outer edges thereof in a force-locking manner (press fit). Alternatively, an interlocking or some other (direct) connection is also possible. The absorber 7 can thus be aligned directly at the antenna 3 or at the printed circuit board 10 carrying the antenna 3. This enables a more accurate positioning of the antenna 3 with respect to the second leadthrough 8.

Optionally, in each case one preferably pin-shaped extension 17 can be formed on at least one axial extension 15 of the absorber 7, and is insertable in each case into an associated hole in the securing carrier 12 with a clearance fit, which can facilitate the mounting of the absorber 7 on the printed circuit board 10. On account of the clearance fit in the securing carrier 12 and the projections 16 engaging around the printed circuit board 10 in a force-locking manner, the absorber 7 is aligned relative to the printed circuit board 10 and not relative to the securing carrier 12, and so a possible manufacturing-dictated lateral offset between the printed circuit board 10 and the securing carrier 12 does not influence the positioning tolerance of the absorber 7 or of the second leadthrough 8 thereof relative to the antenna 3. Optionally, the printed circuit board 10 can be soldered onto the securing carrier 12.

FIG. 4 reveals a third embodiment of a connector 1 according to the invention comprising a sleeve-shaped absorber 7 composed of a material comprising a foam or an elastomer. For the purpose of stably mechanically securing such an absorber 7 to the printed circuit board 10, the absorber 7 is preferably secured at its outer sheath surface to a preferably sleeve-shaped holding element 15-2. The sleeve-shaped holding element 15-2 is produced from a material that preferably comprises a thermoplastic or thermosetting plastic solid material. In order to secure the holding element 15-2 to the printed circuit board 10 and/or to the securing carrier 12, the holding element 15-2 can be shaped equivalently to the absorber 7 in the second embodiment of a connector 1 according to the invention in accordance with FIGS. 2 and 3.

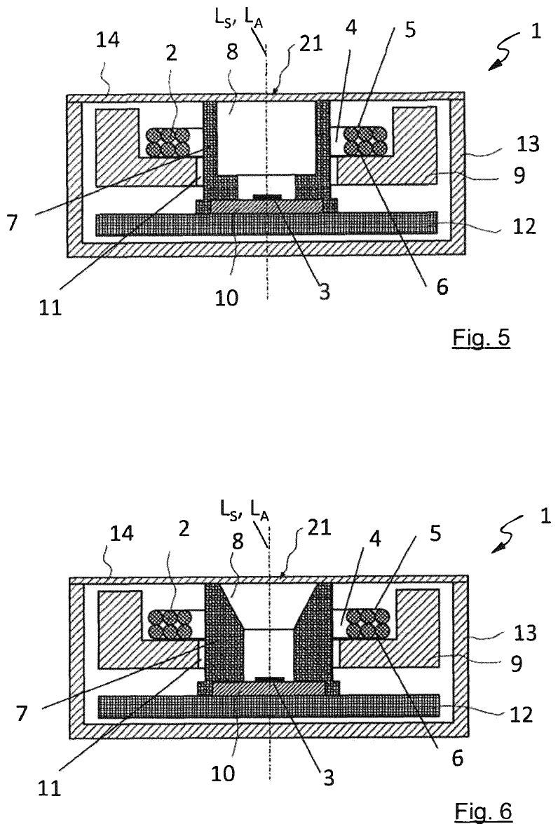

In the fourth embodiment of a connector 1 according to the invention in accordance with FIG. 5, an absorber 7 is illustrated whose internal diameter increases in a stepped manner in the direction of the air interface 21. A portion of an electromagnetic wave that is incident from the mating connector 1′ on the printed circuit board 10 or generally next to the antenna 3 can thus be better damped by means of the absorber 7. Moreover, a surface wave emanating from the antenna 3 can advantageously be damped to a greater extent by the antenna-side taper of the absorber 7.

Optionally, the second leadthrough 8 embodied in a stepped manner can comprise at least two hollow cylinders, for example. The hollow cylinders can be arranged coaxially with respect to the longitudinal axis L_{A} of the second leadthrough 8. Optionally, these hollow cylinders can be wholly or partly filled with a radome material.

In the fifth embodiment of an electrical connector 1 according to the invention in accordance with FIG. 6, the internal diameter of the absorber 7 alternatively increases conically in the direction of the air interface 21, i.e. as far as the cover 14.

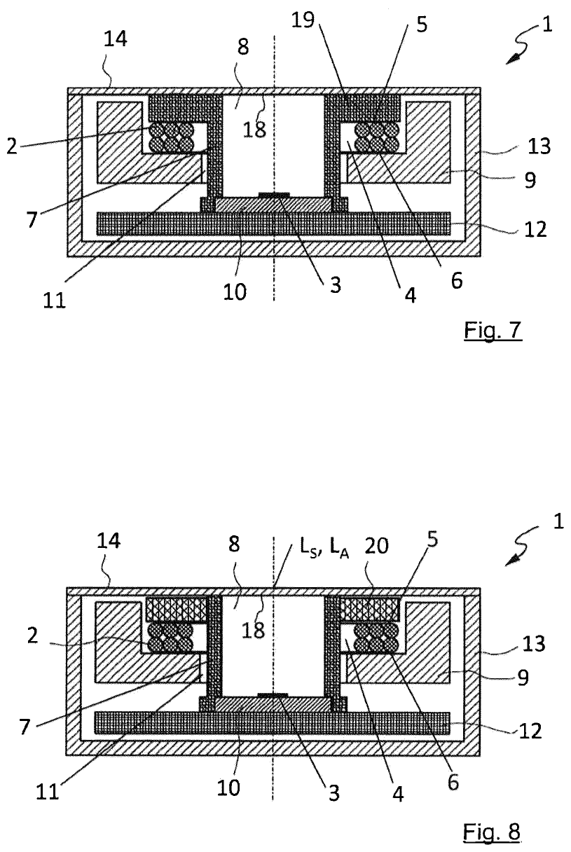

In a sixth embodiment of an electrical connector 1 according to the invention in accordance with FIG. 7, a flange-shaped region 19 is formed at the air-interface-side axial end 18 of the absorber 7, and masks the air-interface-side axial end 5 of the coil 2 and thus reduces reflections of an electromagnetic wave there.

As illustrated in FIG. 8, in a seventh embodiment of a connector 1 according to the invention, the air-interface-side axial end 5 of the coil 2 is masked by an additional sleeve-shaped electromagnetic absorber element 20, which masks the air-interface-side axial end 5 of the coil 2. The absorber element 20, forming a flange-shaped region 19 of the absorber 7, is thus of discrete-part design with respect to the absorber 7 and can optionally comprise a different absorber material, for example an elastomer and/or a foam, compared with the rest of the absorber 7. The additional absorber element 20 can directly adjoin the rest of the absorber 7, which can improve the radio channel between the connector 1 and the mating connector 1′.

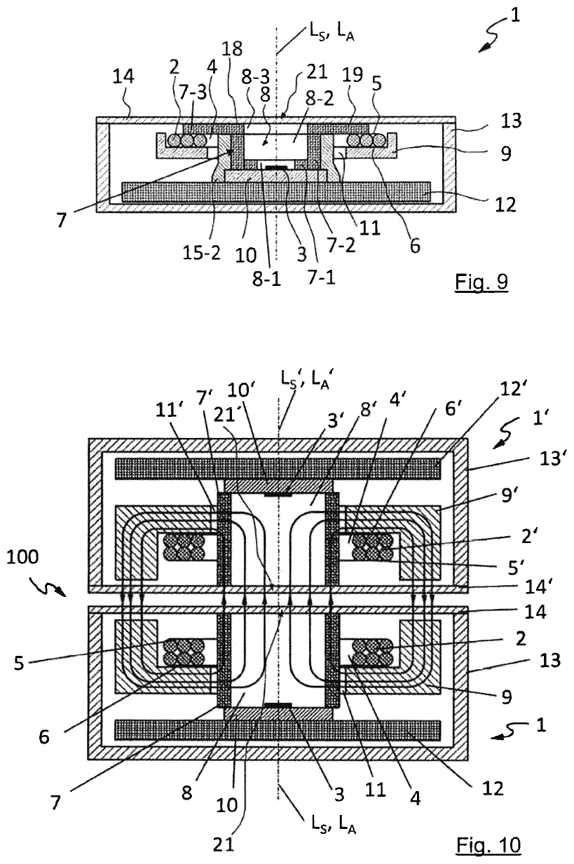

FIG. 9 shows a connector 1 according to the invention in which the sleeve-shaped absorber 7 is of discrete-part and for example three-part design. The absorber 7 comprises a first absorber unit 7-1 mounted directly on the printed circuit board 10. The first absorber unit 7-1 has a first through opening 8-1, which forms a part of the second leadthrough 8 of the absorber 7 and which can have a circular cross section, for example. The longitudinal axis of the first through opening 8-1 runs through the midpoint and/or the phase center of the antenna 3. Moreover, the absorber 7 comprises a second absorber unit 7-2. The second absorber unit 7-2 has a second through opening 8-2, the internal diameter of which can be equal or approximately equal to the external diameter of the first absorber unit 7-1. Consequently, the second absorber unit 7-2 can enter into a fit, for example a press fit, with the first absorber unit 7-1. The second absorber unit 7-2, proceeding from the printed circuit board 10, has a greater longitudinal extent than the first absorber unit 7-1. The second through opening 8-2 can thus also form at least a part of the second leadthrough 8. A longitudinal axis of the second through opening 8-2 can be aligned with a longitudinal axis of the first through opening 8-1. With the first and second absorber units 7-1, 7-2 embodied in this way, the diameter of the second leadthrough 8 can thus increase toward the air interface 21. The second absorber unit 7-2 is connected to a holding element 15-2 on the outer sheath side.

Optionally, the absorber 7 can comprise a third absorber unit 7-3, which can form a flange-shaped region 19 at the air-interface-side axial end 18 of the absorber 7. The third absorber unit 7-3 has a third through opening 8-3 forming a part of the second leadthrough 8. An internal diameter of the third through opening 8-3 can be equal or approximately equal to an internal diameter of the second through opening 8-2. The second absorber unit 7-2 extends in the longitudinal direction as far as the third absorber unit 7-3.

At least one absorber unit of the first, second or third absorber unit 7-1, 7-2, 7-3 can comprise an elastomer-based and/or foam-based absorber material. It is furthermore optionally possible for the first absorber unit 7-1 to comprise a resonance-based absorber material and for the second and/or the third absorber unit 7-2, 7-3 to comprise a loss-based absorber material.

FIG. 10 shows a system 100 comprising a connector 1 and an associated mating connector 1′, which can be realized structurally identically to the connector 1. In regard to the transmitter and receiver power electronics used for the energy transfer, however, the connector 1 and the mating connector 1′ can differ and, for example, it is possible for transmission electronics to be provided only in the connector 1 and only receiver electronics for the energy transfer to be provided in the mating connector 1′. The longitudinal axis L_{A} of the second leadthrough 8 and the longitudinal axis L_{S} of the first leadthrough 4 of the first connector 1 are aligned with the longitudinal axis LA' of the second leadthrough 8′ and with the longitudinal axis L_{S}′ of the first leadthrough 4′ of the mating connector 1′. The air interface 21 of the first connector 1 is arranged opposite preferably in a manner spaced apart from the air interface 21′ of the mating connector 1′. Generally, however, it is also possible for the two covers 14 and 14′ to touch, for example if the connector and mating connector are intended to provide a galvanic, but not completely contactless isolation of a combined energy and data transfer. At least the connector 1 or the mating connector 1′ is rotatable about a rotation axis which lies in each case on the longitudinal axis L_{A} of the second leadthrough 8 and/or the longitudinal axis L_{S} of the first leadthrough 4 of the connector 1 or respectively on the longitudinal axis L_{A}′ of the second leadthrough 8′ and/or the longitudinal axis L_{S}′ of the first leadthrough 4′ of the second mating connector 1′.

Analogously to the connector 1, the mating connector 1′ comprises a preferably sleeve-shaped coil 2′ for contactless energy transfer, the first leadthrough 4′ of which extends from an antenna-side axial end 6′ as far as an air-interface-side axial end 5′ of the coil 2′. Arranged in the first leadthrough 4′ there is a preferably sleeve-shaped absorber 7′ extending as far as a printed circuit board 10′. On the printed circuit board 10′, an antenna 3′ for contactless data transfer is preferably arranged symmetrically with respect to the longitudinal axis L_{A}′ of the second leadthrough 8′. In order to increase the range between the connector 1 and the mating connector 1′, the magnetic flux of the coil 2′ is partly guided in a ferrite core 9′ formed adjacent to the coil 2′ preferably only radially outside the coil 2′ and only at the antenna-side axial end 6′ of the coil 2′. The absorber 7′ is led through a third leadthrough 11′ of the ferrite core 9′. The antenna 3′ of the mating connector 1′ radiates and/or receives an electromagnetic wave through the second leadthrough 8′ of the absorber 7′. The printed circuit board 10′ with the antenna 3′ is fixed to a securing carrier 12′. The mating connector 1′ is incorporated in a housing 13′, which is closed off by a cover 14′ at the air interface 21′.

### Operation

Having described the structure of our electrical connector its operation is described.

A principal object of the present invention is an electrical connector (D) having an antenna (3) for contactless data transfer and a sleeve-shaped coil (2) for contactless energy transfer. The coil (2) defines a first leadthrough (between an air-interface-side axial end (5) of the coil (2) and an antenna-side axial end (6) of the coil (2). A sleeve-shaped electromagnetic absorber (7) defines a second leadthrough (8) designed to allow propagation for an electromagnetic wave. The absorber (7) is arranged within the first leadthrough (4) and the antenna (3) is arranged relative to the antenna-side axial end (6) in such a way that a main radiating direction HR_{D} of the antenna (3) passes through the second leadthrough (8).

A further object of the present invention is an electrical connector (1) comprising: an antenna (3) for contactless data transfer; and a coil (2) that is sleeve-shaped for contactless energy transfer, the sleeve-shaped coil (2) defining a first leadthrough (4) between an air-interface-side axial end (5) of the sleeve-shaped coil (2) and an antenna-side axial end (6) of the sleeve-shaped coil (2): and an electromagnetic absorber (7) that is sleeve-shaped. the sleeve-shaped electromagnetic absorber (Z) defining a second leadthrough (8) to allow propagation for an electromagnetic wave; and wherein the sleeve-shaped electromagnetic absorber (7) is arranged within the first leadthrough (4) defined by the sleeve shaped coil (2); and the antenna (3) is arranged relative to the antenna-side axial end (6) of the sleeve-shaped coil (2) in such a way that a main radiating direction HR_{D} of the antenna (3) passes through the second leadthrough (8) defined by the sleeve-shaped electromagnetic absorber (7)

A further object of the present invention is an electrical connector (1) wherein the sleeve-shaped electromagnetic absorber (7) extends at least over a longitudinal extent of the first leadthrough (4).

A further object of the present invention is an electrical connector (1) wherein the sleeve-shaped electromagnetic absorber (7) extends in a longitudinal direction as far as the antenna (3).

A further object of the present invention is an electrical connector (1) wherein the sleeve-shaped electromagnetic absorber (7) is produced from a material comprising an elastomer, or a foam; and wherein the sleeve-shaped electromagnetic absorber (7) preferably on an outer sheath side thereof is connected to a holding element (15-2), and the holding element (15-2) is composed of a thermoplastic or thermosetting plastic absorber material.

A further object of the present invention is an electrical connector (1) further comprising: a flange-shaped region (19) of the sleeve-shaped electromagnetic absorber (7) at the air-interface-side axial end (5) of the sleeve-shaped coil (2) and/or at the antenna-side axial end (6) of the sleeve-shaped coil (2)

A further object of the present invention is an electrical connector (1) wherein the flange-shaped region (19) of the sleeve-shaped electromagnetic absorber (7) is of discrete-part design with respect to the sleeve-shaped electromagnetic absorber (7)

A further object of the present invention is an electrical connector (1) wherein the flange-shaped region (19) of the sleeve-shaped electromagnetic absorber (Z) is produced from a material comprising an elastomer, or comprising a foam.

A further object of the present invention is an electrical connector (1) and wherein a diameter of the second leadthrough (8) increases laterally or radially in the direction of an air-interface-side axial end of the sleeve-shaped electromagnetic absorber (7).

A further object of the present Invention is an electrical connector (1) and further comprising: a ferrite core (9), which runs along an outer sheath surface of the sleeve-shaped coil (2) and an end surface of the sleeve-shaped coil (2) formed at the antenna-side axial end (6) of the sleeve-shaped coil (2); and wherein the ferrite core (9) defines a third leadthrough (11), and the third leadthrough (11) is aligned with the first leadthrough (4) of the sleeve-shaped coil (2); and the sleeve-shaped electromagnetic absorber (7) extends at least along the longitudinal extent of the third leadthrough (LI).

A further object of the present invention is an electrical connector (1) wherein sleeve-shaped coil (2) is configured to inductively transfer energy in a first frequency range; and the antenna (3) is configured to transfer data in a second frequency range different than the first frequency range; and the sleeve-shaped electromagnetic absorber (7) is configured to be electromagnetically transmissive in the first frequency range and electromagnetically absorbent in the second frequency range

A further object of the present invention is an electrical connector (1) wherein the antenna (3) is circularly polarized.

A further object of the present invention is an electrical connector (1) wherein the antenna (3) is configured to carry out an in-band full-duplex data transfer; and a center axis of the antenna (3) is aligned with a longitudinal axis L_{A} of the second leadthrough (8) defined by the sleeve-shaped electromagnetic absorber (7).

A further object of the present invention is an electrical connector (1) wherein the second leadthrough (8) is of rotationally symmetrical design.

A further object of the present invention is an electrical connector (1) wherein at least one region of the sleeve-shaped electromagnetic absorber (7) is produced from a thermoplastic or thermosetting plastic material, and the at least one region of the sleeve-shaped electromagnetic absorber (7) is fixed to the antenna (3) directly.

A further object of the present invention is a system (100) for contactless data transfer and for contactless energy transfer comprising: a first electrical connector (1), the first electrical connector (1) having, an antenna (3) for the contactless data transfer, and a coil (2) that is sleeve-shaped for the contactless energy transfer, the sleeve-shaped coil (2) defining a first leadthrough (4) between an air-interface-side axial end(S) of the sleeve-shaped coil (2) and an antenna-side axial end (6) of the sleeve-shaped coil (2), and an electromagnetic absorber (7) that is sleeve-shaped, the sleeve-shaped electromagnetic absorber (7) defining a second leadthrough (8) to allow propagation for an electromagnetic wave, and wherein the sleeve-shaped electromagnetic absorber (7) is arranged within the first leadthrough (4), and the antenna (3) is arranged relative to the antenna-side axial end (6) of the sleeve-shaped coil (2) in such a way that a main radiating direction HR_{D} of the antenna (3) passes through the second leadthrough (8); and an associated electrical mating connector (1′), the associated electrical mating connector (1′) having, an antenna (3′) for the contactless data transfer, and a coil (2′) that is sleeve-shaped for the contactless energy transfer, the sleeve-shaped coil (2′) defining a first leadthrough (4′) between an air-interface-side axial end (5′) of the sleeve shaped coil (2) and an antenna-side axial end (6) of the sleeve-shaped coil (2′), and an electromagnetic absorber (7′) that is sleeve-shaped, the sleeve-shaped electromagnetic absorber (7′) defining a second leadthrough (8′) to allow propagation for an electromagnetic wave, and wherein the sleeve-shaped electromagnetic absorber (7′) is arranged within the first leadthrough (4′), and the antenna (3) is arranged relative to the antenna-side axial end (6′) of the sleeve-shaped coil (2′) in such a way that a main radiating direction HR_{D} of the antenna (3′) passes through the second leadthrough (8); and an air interface (21) of the first electrical connector (1) is arranged opposite an air interface (21′) of the associated electrical mating connector (1′); and wherein the first electrical connector (1) and/or the associated electrical mating connector (1′) are/is rotatable about a longitudinal axis (L_{A}, L_{A}′) of the respective second leadthrough (8, 8′).

A still further object of the present invention is an electrical connector (D) wherein the main radiating direction HR_{D} of the antenna (3) is aligned with a longitudinal axis L_{A} of the second leadthrough (8) defined by the sleeve-shaped electromagnetic absorber (Z).

An even still further object of the present invention is an electrical connector (1) wherein the at least one region of the sleeve-shaped electromagnetic absorber (7) is fixed to the antenna (3) by a press fit

In compliance with the statute, the present invention has been described in language more or less specific, as to structural and methodical features. It is to be understood, however, that the invention is not limited to the specific features shown and described since the means herein disclosed comprise preferred forms of putting the invention into effect. The invention is. therefore, claimed in any of its forms or modifications within the proper scope of the appended claims appropriately interpreted in accordance with the Doctrine of Equivalents.

1. An electrical connector (1) comprising:
an antenna (3) for contactless data transfer; and
a coil (2) that is sleeve-shaped for contactless energy transfer, the sleeve-shaped coil (2) defining a first leadthrough (4) between an air-interface-side axial end (5) of the sleeve-shaped coil (2) and an antenna-side axial end (6) of the sleeve-shaped coil (2); and
an electromagnetic absorber (7) that is sleeve-shaped, the sleeve-shaped electromagnetic absorber (7) defining a second leadthrough (8) to allow propagation for an electromagnetic wave; and
the sleeve-shaped electromagnetic absorber (7) is arranged within the first leadthrough (4) defined by the sleeve shaped coil (2); and
the antenna (3) is arranged relative to the antenna-side axial end (6) of the sleeve-shaped coil (2) in such a way that a main radiating direction HR_{D} of the antenna (3) passes through the second leadthrough (8) defined by the sleeve-shaped electromagnetic absorber (7).

2. The electrical connector (1) as claimed in claim 1 and wherein the sleeve-shaped electromagnetic absorber (7) extends at least over a longitudinal extent of the first leadthrough (4),

3. The electrical connector (1) as claimed in claim 1 and wherein the sleeve-shaped electromagnetic absorber (7) extends in a longitudinal direction as far as the antenna (3).

4. The electrical connector (1) as claimed in claim 1 and wherein the sleeve-shaped electromagnetic absorber (7) is produced from a material comprising an elastomer, or a foam; and
the sleeve-shaped electromagnetic absorber (7) preferably on an outer sheath side thereof is connected to a holding element (15-2), and the holding element (15-2) is composed of a thermoplastic or thermosetting plastic absorber material.

5. The electrical connector (1) as claimed in claim 1 and further comprising:
flange-shaped region (19) of the sleeve-shaped electromagnetic absorber (7) at the air-interface-side axial end (5) of the sleeve-shaped coil (2) and/or at the antenna-side axial end (6) of the sleeve-shaped coil (2).

6. The electrical connector (1) as claimed in claim 5 and wherein the flange-shaped region (19) of the sleeve-shaped electromagnetic absorber (7) is of discrete-part design with respect to the sleeve-shaped electromagnetic absorber (7).

7. The electrical connector (1) as claimed in claim 5 and wherein the flange-shaped region (19) of the sleeve-shaped electromagnetic absorber (7) is produced from a material comprising an elastomer, or comprising a foam,

8. The electrical connector (1) as claimed in claim 1 and wherein a diameter of the second leadthrough (8) increases laterally or radially in the direction of an air-interface-side axial end of the sleeve-shaped electromagnetic absorber (7).

9. The electrical connector (1) as claimed in claim 1 and further comprising:
a ferrite core (9), which preferably runs along an outer sheath surface of the sleeve-shaped coil (2) and an end surface of the sleeve-shaped coil (2) formed at the antenna-side axial end (6) of the sleeve-shaped coil (2); and wherein
the ferrite core (9) defines a third leadthrough (11), and the third leadthrough (11) is aligned with the first leadthrough (4) of the sleeve-shaped coil (2); and
the sleeve-shaped electromagnetic absorber (7) extends at least along the longitudinal extent of the third leadthrough (11).

10. The electrical connector (1) as claimed in claim 1 and wherein the sleeve-shaped coil (2) is configured to inductively transfer energy in a first frequency range; and
the antenna (3) is configured to transfer data in a second frequency range different than the first frequency range; and
the sleeve-shaped electromagnetic absorber (7) is configured to be electromagnetically transmissive in the first frequency range and electromagnetically absorbent in the second frequency range.

11. The electrical connector (1) as claimed in claim 1 and wherein the antenna (3) is circularly polarized.

12. The electrical connector (1) as claimed in claim 1 and wherein the antenna (3) is configured to carry out an in-band full-duplex data transfer; and
a center axis of the antenna (3) is aligned with a longitudinal axis L_{A} of the second leadthrough (8) defined by the sleeve-shaped electromagnetic absorber (7).

13. The electrical connector (1) as claimed in claim 1 and wherein the second leadthrough (8) is of rotationally symmetrical design.

14. The electrical connector (1) as claimed in claim 1 and wherein at least one region of the sleeve-shaped electromagnetic absorber (7) is produced from a thermoplastic or thermosetting plastic material, and the at least one region of the sleeve-shaped electromagnetic absorber (7) is fixed to the antenna (3) directly.

15. A system (100) for contactless data transfer and for contactless energy transfer comprising:
a first electrical connector (1), the first electrical connector (1) having,
an antenna (3) for the contactless data transfer, and
a coil (2) that is sleeve-shaped for the contactless energy transfer the sleeve-shaped coil (2) defining a first leadthrough (4) between an air-interface-side axial end (5) of the sleeve-shaped coil (2) and an antenna-side axial end (6) of the sleeve-shaped coil (2), and
an electromagnetic absorber (7) that is sleeve-shaped, the sleeve-shaped electromagnetic absorber (7) defining a second leadthrough (8) to allow propagation for an electromagnetic wave, and wherein
the sleeve-shaped electromagnetic absorber (7) is arranged within the first leadthrough (4), and the antenna (3) is arranged relative to the antenna-side axial end (6) of the sleeve-shaped coil (2) in such a way that a main radiating direction HR_{D} of the antenna (3) passes through the second leadthrough (8); and
an associated electrical mating connector (1′), the associated electrical mating connector (1′) having.
an antenna (3′) for the contactless data transfer, and
a coil (2′) that is sleeve-shaped for the contactless energy transfer the sleeve-shaped coil (2′) defining a first leadthrough (4′) between an air-interface-side axial end (5′) of the sleeve-shaped coil (2′) and an antenna-side axial end (6′) of the sleeve-shaped coil (2′), and
an electromagnetic absorber (7′) that is sleeve-shaped, the sleeve-shaped electromagnetic absorber (7′) defining a second leadthrough (8) to allow propagation for an electromagnetic wave, and wherein
the sleeve-shaped electromagnetic absorber (7′) is arranged within the first leadthrough (4′), and the antenna (3′) is arranged relative to the antenna-side axial end (6′) of the sleeve-shaped coil (2″) in such a way that a main radiating direction HR_{D} of the antenna (3′) passes through the second leadthrough (8); and
an air interface (21) of the first electrical connector (1) is arranged opposite an air interface (21′) of the associated electrical mating connector (1′); and wherein
the first electrical connector (1) and/or the associated electrical mating connector (1′) are/is rotatable about a longitudinal axis (L_{A}, L_{A}′) of the respective second leadthrough (8, 8′).

16. The electrical connector (1) as claimed in claim 1 and wherein the main radiating direction HR_{D} of the antenna (3) is aligned with a longitudinal axis L_{A} of the second leadthrough (8) defined by the sleeve-shaped electromagnetic absorber (7).

17. The electrical connector (1) as claimed in claim 14 and wherein the at least one region of the sleeve-shaped electromagnetic absorber (7) is fixed to the antenna (3) by a press fit.
